(19) United States
(12) Patent Application Publication
(10) Pub. No.: US 2006/0096079 A1
(43) Pub. Date: May 11, 2006

(54) Apparatus for forming continuous metal grids, in particular producing grids for batteries

(75) Inventor: Pietro Farina, Villafranca (Verona) (IT)

Correspondence Address: BROWDY AND NEIMARK, P.L.L.C.;624 NINTH STREET, NW, SUITE 300, WASHINGTON, DC, 20001-5303, US

(73) Assignee: Sovema S.p.A., Villafranca (VR) (IT)

(21) Appl. No.: 11/062,575

(22) Filed: Feb. 23, 2005

(30) Foreign Application Priority Data
Nov. 5, 2004 (IT) IT-VR2004A000173

(51) Int. Cl. B21D 53/00; B23P 23/00

(52) U.S. Cl. 29/564; 29/34 R

(57) ABSTRACT

An apparatus for forming continuous metal grids, in particular producing grids for batteries, comprises a supporting structure, at least one punching roller and at least one matrix roller mounted on the supporting structure. The punching roller and the matrix roller respectively have a first and a second outer surface. The punching roller comprises a plurality of first teeth positioned radially relative to the first outer surface and each cyclically mobile, with each punching roller rotation, between an operating position in which it projects from the first outer surface and a non-operating position in which it does not project from the first outer surface. The matrix roller comprises a plurality of second teeth positioned radially relative to the second outer surface and each cyclically mobile, with each matrix roller rotation, between a passive position in which it is retracted relative to the second outer surface and an active position in which it is not retracted relative to the second outer surface. In the operating zone each first tooth is partly inserted in the matrix roller where a second tooth is retracted in the matrix roller.

### BACKGROUND OF THE INVENTION

The present invention relates to an apparatus for forming continuous metal grids, in particular producing grids for batteries, from a continuous band of metal material.

The present invention is designed for the sector for the production of batteries.

Batteries comprise inside them a plurality of metal grids joined together to form packs.

At present many technologies for the production of grids for batteries are known.

A first known technology, which allows good quality grids to be obtained, involves the production of grids by casting. However, it is a solution with quite limited productivity.

Therefore, to increase productivity, various apparatuses were developed which allow grids to be obtained directly from a continuous band of the desired material (for example lead).

In particular two types of apparatuses for the production of grids from a continuous band are currently widespread, those that produce the grid by expansion and those that produce the grid by punching.

The former are apparatuses in which the grid is obtained by deforming the band, penetrating it with a succession of special shaped teeth.

This technology allows high productivity without processing waste. However, the grids obtained are not of optimum quality, since they have irregular and/or deformed inner strips, in particular when the dimensions of the strips are small.

In contrast, when the grids are produced by punching, the apparatuses are equipped with rigid punches which strike the band cyclically at a matrix die below which forms a hollow at each punch, thus removing small blocks.

At present both static punch apparatuses, in which the band is fed with a stepping motion, and dynamic punch apparatuses, in which the band is fed practically continuously are known.

The latter category includes both apparatuses in which the punches move with a double oscillating motion (parallel with and perpendicular to the band), and apparatuses in which the punches are rigidly mounted on a roller paired with a matrix roller with the hollows. In the latter case there are also mobile pushers able to expel from the hollows the material removed during punching.

However, even the current apparatuses which use punching to obtain grids are not without disadvantages.

Indeed, if on one hand static punching machines have limited productivity, on the other hand the dynamic punching machines known today do not allow the production of grids with small inner strips and/or a large number of holes per surface unit.

When punching is performed, the grid remains caught between the different punches and therefore has to be detached with special devices. As a result, if punching were performed on grids with thin strips (below a threshold value which depends on the material and geometry of the grid), when the grid were extracted from the punches the individual strips would be irreparably damaged. This problem would be even more noticeable in the case of grids with a high density of holes.

### SUMMARY OF THE INVENTION

In this situation the technical need which forms the basis of the present invention is the production of an apparatus for forming continuous metal grids, in particular producing grids for batteries, which overcomes the above-mentioned disadvantages.

In particular, the technical need of the present invention is the production of an apparatus for forming continuous metal grids, in particular producing grids for batteries, which allows the formation of grids with inner strips of any thickness and with a high density of holes.

Another technical need of the present invention is the production of an apparatus for forming continuous metal grids, in particular producing grids for batteries, which allows the production of optimum quality grids with high productivity.

The technical need specified and the aims indicated are substantially fulfilled by an apparatus for forming continuous metal grids, in particular producing grids for batteries, as described in the claims herein.

### BRIEF DESCRIPTION OF THE DRAWINGS

Further features and the advantages of the present invention are more clearly illustrated in the detailed description below, with reference to the accompanying drawings, which illustrate several preferred embodiments of an apparatus for forming continuous metal grids, in particular producing grids for batteries, without limiting the scope of its application, and in which:

FIG. 1 is a side view of an apparatus made according to the present invention;

FIG. 2 is a view of the apparatus illustrated in FIG. 1 according to line II-II;

FIG. 3 is a view of the apparatus illustrated in FIG. 1 according to line III-III;

FIG. 4 is a front view of the apparatus illustrated in FIG. 1 (from the right with reference to FIG. 1);

FIG. 5 is a cross-section with some parts cut away of the apparatus illustrated in FIG. 4 according to line V-V (with lines II-II and III-III illustrated in FIG. 1 also labeled);

FIG. 6 is a front view, with some parts cut away, of a punching roller belonging to the apparatus illustrated in FIG. 1;

FIG. 7 is a side view of the punching roller illustrated in FIG. 6;

FIG. 8 is a partial cross-section of the roller illustrated in FIG. 6 according to line VIII-VIII;

FIG. 9 is a three-quarter axonometric view, partly in cross-section, of the punching roller illustrated in FIG. 6;

FIG. 10 is a three-quarter axonometric view, partly in cross-section, of a matrix roller belonging to the apparatus illustrated in FIG. 1;

FIG. 11 is a three-quarter axonometric view, partly in cross-section, of an alternative embodiment of the punching roller illustrated in FIG. 9;

FIG. 12 is an enlarged detail of an operating zone of the apparatus illustrated in FIG. 1;

FIG. 13 is an enlarged detail of the apparatus illustrated in FIG. 12;

FIG. 14 is a front view of a grid 2 for batteries which can be obtained with an apparatus made according to the present invention;

FIG. 15 illustrates a processed band which can be obtained with an apparatus made according to the present invention; and

FIG. 16 is an enlarged detail of a coupling zone of the apparatus illustrated in FIG. 5.

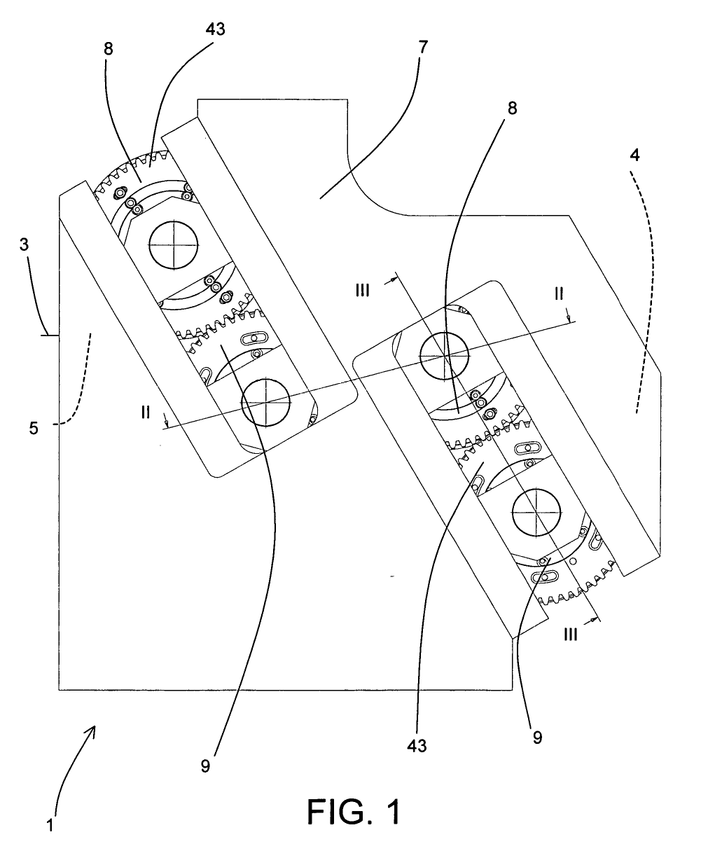

### DESCRIPTION OF THE PREFERRED EMBODIMENTS

With reference to the accompanying drawings, the numeral 1 denotes as a whole an apparatus for forming continuous metal grids, in particular producing grids 2 for batteries, according to the present invention.

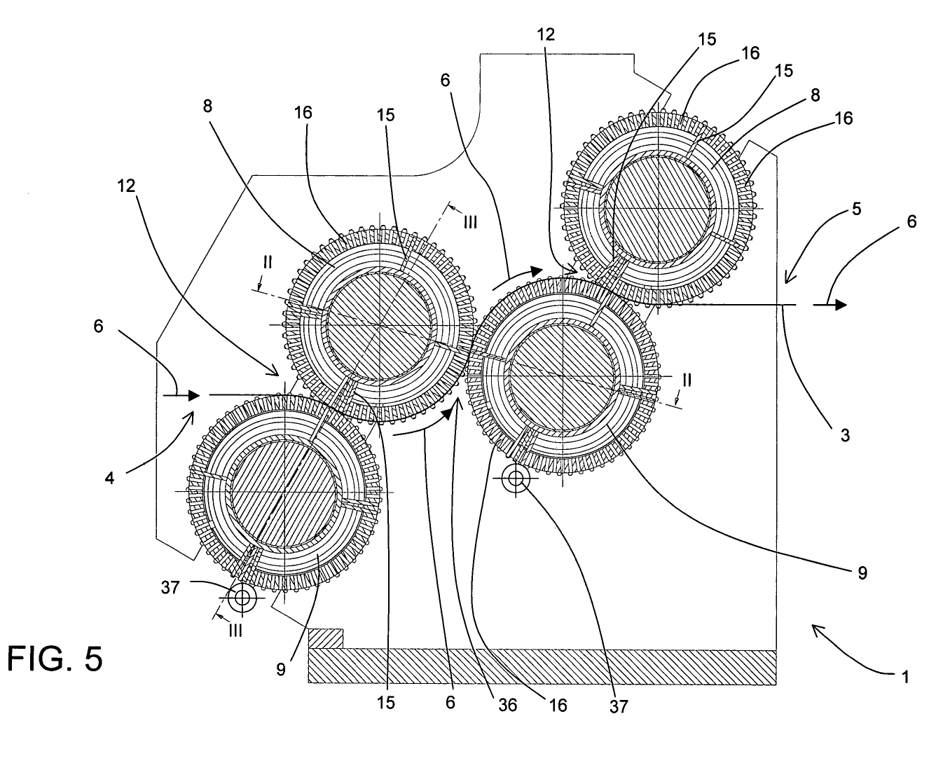

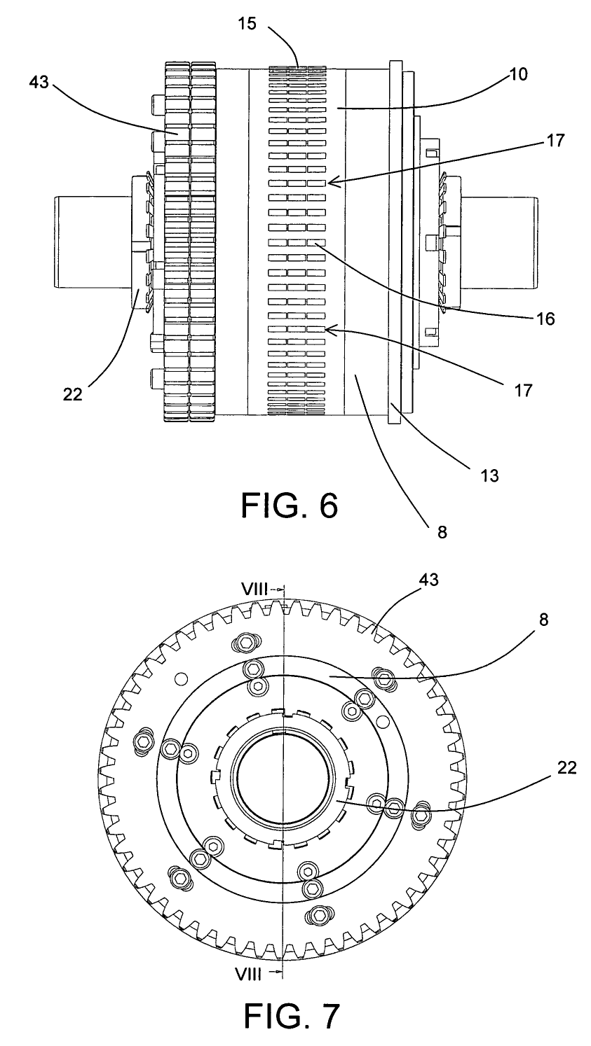

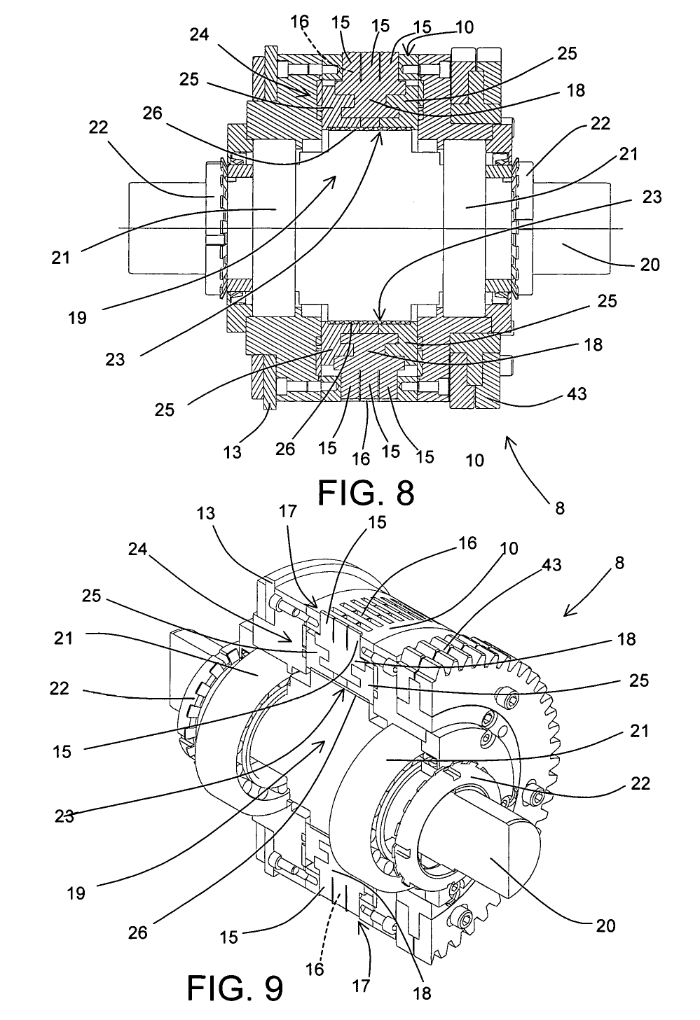

Inside the apparatus 1 there is a feed path for a continuous metal band 3, a path extending from an infeed section 4 to an outfeed section 5 (the path indicated by the arrows 6 in FIG. 5).

In the most general embodiment, the apparatus 1 comprises firstly a supporting structure 7 on which there are mounted at least one punching roller 8 and at least one matrix roller 9. However, according to requirements, the apparatus 1 may comprise a plurality of punching rollers 8, each paired with a matrix roller 9.

In particular in the embodiment illustrated, the apparatus 1 comprises two punching roller 8-matrix roller 9 pairs, arranged one after another along the band 3 feed path.

Hereinafter, unless otherwise indicated, when reference is made to the punching roller 8 or to the matrix roller 9, it shall be intended to refer to all of the punching rollers 8 and all of the matrix rollers 9 present in the apparatus 1.

The punching roller 8 is positioned transversally to the band 3 feed path and has a first outer surface 10 designed, in practice, to remain in contact with a face of the continuous band 3.

In turn, the matrix roller 9 is positioned parallel with the punching roller 8 and in the corresponding position to it on the opposite side of the band 3 feed path. Moreover, the matrix roller 9 has a second outer surface 11 designed, in practice, to remain in contact with the other face of the continuous band 3, relative to the first outer surface 10.

At a band 3 path operating zone 12, the first and the second outer surfaces 10, 11 are separated from one another by a distance substantially corresponding to the thickness of the band 3. Again at the operating zone 12, in practice, the first and the second outer surfaces 10, 11 are in contact with the band 3.

The punching roller 8 and the matrix roller 9 are motor-driven (the drive unit is not illustrated, since it is of the known type) and rotate in opposite directions and in such a way that they are synchronized, with a peripheral speed that in practice substantially corresponds to the band 3 feed speed. In the embodiments illustrated, synchronization is guaranteed by mechanical transmission of the motion between the two rollers 8, 9, by at least two gear wheels 43 integral with the rollers.

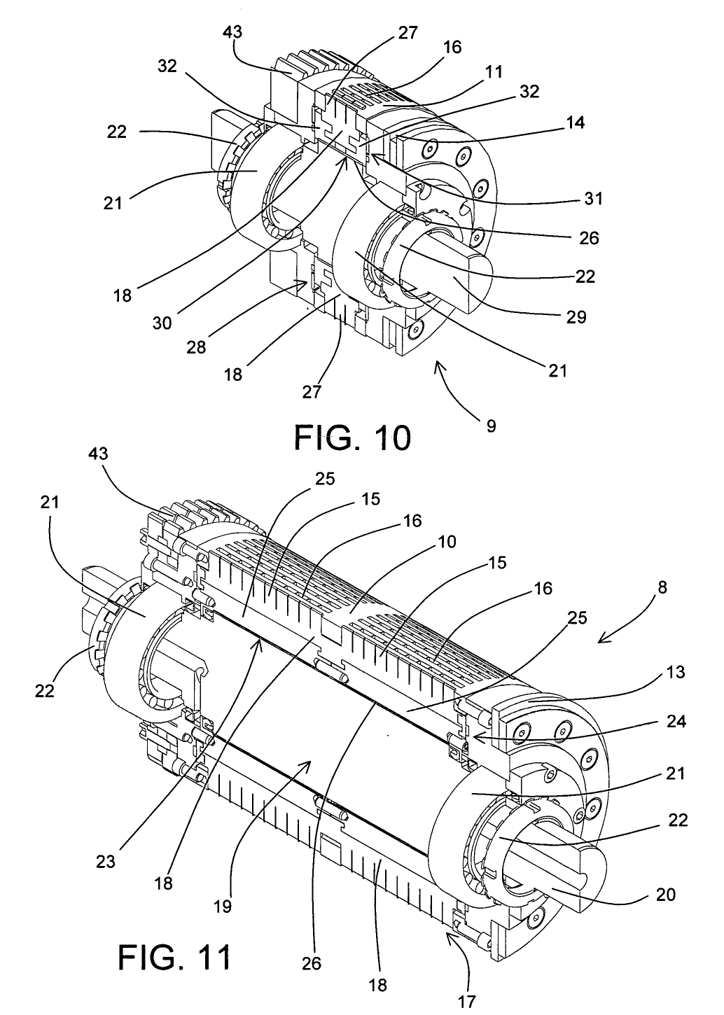

As illustrated in particular in FIGS. 3, 9, 10 and 11, the punching roller 8 is also equipped with a projecting peripheral ring 13 designed to be inserted in a peripheral groove 14 made in the matrix roller 9, to guarantee correct reciprocal positioning of the rollers 8, 9.

According to the present invention, the punching roller 8 also comprises a plurality of first teeth 15 positioned radially relative to the first outer surface 10. The first teeth 15 are slidably inserted in radial seats 16 made in the punching roller 8 from the first outer surface 10. Each first tooth 15 is cyclically mobile, with each rotation of the punching roller 8, between an operating position in which it projects from the first outer surface 10 and a non-operating position in which it does not project from the first outer surface 10.

According to requirements, the first teeth 15, when in the non-operating position, may be either positioned substantially aligned with the first outer surface 10, so that they substantially form a continuation of it, or retracted in their seats 16 relative to the first outer surface 10.

Advantageously, the first teeth 15 are regularly distributed on the first outer surface 10, along a plurality of rows 17 parallel with the axis of rotation of the relative roller 8, 9. Moreover, the first teeth 15 of each row 17 are preferably grouped in one or more rigid blocks 18, so that they can move in step with one another.

The movement of the first teeth 15 is guaranteed by first drive means 19 inserted inside the punching roller 8.

In particular, in the embodiments illustrated, the first drive means 19 comprise a first shaft 20 positioned inside the punching roller 8 on which the punching roller 8 is rotatably mounted by means of bearings 21. Correct positioning of the roller is guaranteed by two centering rings 22.

The first shaft 20 is integral with the supporting structure 7 and remains stationary during the rotation of the punching roller 8.

To drive the movement of the first teeth 15, the first shaft 20 has a first cam surface 23 relative to the axis of rotation of the punching roller 8. In the embodiment illustrated, the first cam surface 23 consists of a first cylindrical surface positioned eccentrically relative to the axis of rotation of the punching roller 8 (which, in the accompanying drawings, corresponds to the axis of the first shaft 20).

As illustrated in the accompanying drawings, there are also first mechanical means 24 connected to the first teeth 15 and slidably connected to the first cam surface 23 to follow its movement during punching roller 8 rotation. In particular, in the embodiment described here, the first mechanical means 24 comprise at least a first ring 25, its inside shaped to match the first cylindrical surface and rotatably mounted on the latter, to which the first teeth 15 are coupled. However, there are preferably two first rings 25 which grip the two sides of the blocks 18 which form the various rows 17 of first teeth 15.

To improve the sliding of the first rings 25 on the first cam surface 23, there are also bushings 26 inserted between them.

In the embodiment illustrated in the accompanying drawings, the matrix roller 9 is substantially similar to the punching roller 8.

In particular, the matrix roller 9 comprises a plurality of second teeth 27 positioned radially relative to the second outer surface 11. Similarly to the first teeth 15, the second teeth 27 are slidably inserted in radial seats 16 made in the matrix roller 9 from the second outer surface 11. Each second tooth 27 is cyclically mobile, with each rotation of the matrix roller 9, between a passive position in which it is retracted relative to the second outer surface 11 and an active position in which it is not retracted relative to the second outer surface 11.

According to requirements, when they are in the active position, the second teeth 27 may be either substantially aligned with the second outer surface 11, so that they substantially form a continuation of it, or projecting from it.

Advantageously, the second teeth 27 are also regularly distributed on the second outer surface 11, along a plurality of rows 17 parallel with the axis of rotation of the relative roller. Moreover, the second teeth 27 of each row 17 are preferably grouped in one or more rigid blocks 18, so that they can move in step with one another.

As is more clearly described below, the positioning of the second teeth 27 on the second outer surface 11 must also reflect that of the first teeth 15 on the first outer surface 10.

The movement of the second teeth 27 is guaranteed by second drive means 28 inserted in the matrix roller 9.

In particular, in the embodiments illustrated, the second drive means 28 comprise a second shaft 29 positioned inside the matrix roller 9 on which the matrix roller 9 is rotatably mounted by means of bearings 21. Correct positioning of the roller is guaranteed by two centering rings 22, similarly to the case of the punching roller 8.

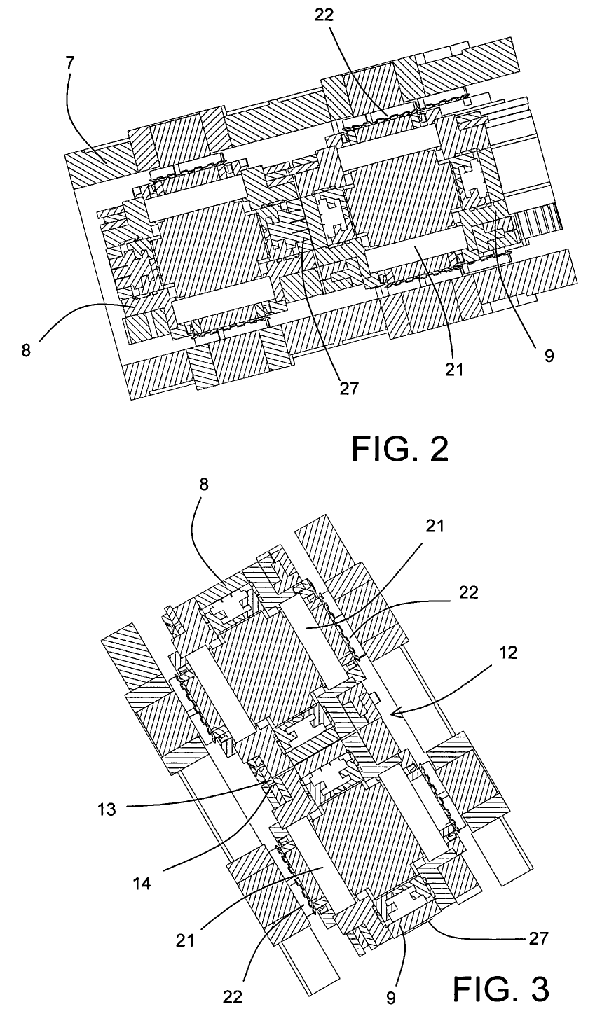

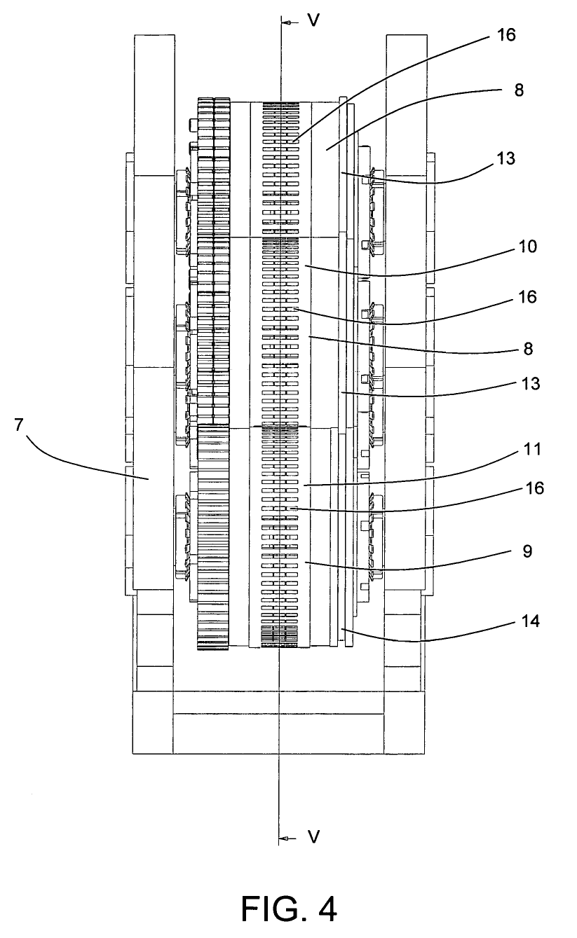

It should be noticed that FIGS. 2 and 3 show neither the bearings 21 nor the centering rings 22 of any of the rollers 8, 9.

The second shaft 29 is integral with the supporting structure 7 and remains stationary during matrix roller 9 rotation.

To drive the movement of the second teeth 27, the second shaft 29 has a second cam surface 30 relative to the axis of rotation of the matrix roller 9. In the embodiment illustrated, the second cam surface 30 also consists of a second cylindrical surface positioned eccentrically relative to the axis of rotation of the matrix roller 9 (which, in the accompanying drawings, corresponds to the axis of the second shaft 29).

As illustrated in the accompanying drawings, there are second mechanical means 31 connected to the second teeth 27 and slidably connected to the second cam surface 30 to follow its movement during matrix roller 9 rotation. In particular, in the embodiment described here, the second mechanical means 31 comprise at least one second ring 32, its inside shaped to match the second cylindrical surface and rotatably mounted on the latter, to which the second teeth 27 are coupled. However, in this case too, there are preferably two second rings 32 which grip the two sides of the blocks 18 forming the various rows 17 of second teeth 27.

To improve the sliding of the second rings 32 on the second cam surface 30, there are also bushings 26 inserted between them.

In all of the accompanying drawings, for greater clarity, for each roller 8, 9 only several first and second teeth 15, 27 are illustrated. Instead, for all of the others only the respective radial seats 16 are visible (see FIG. 5 in particular).

Although a particular embodiment of the first and the second drive means 19, 28 is described here, any other type may be used without thereby departing from the scope of the inventive concept.

The punching roller 8 and the matrix roller 9 are positioned, relative to the band 3 path, in such a way that when the first and second teeth 15, 27 are at the operating zone 12, the first teeth 15 are in their operating position and the second teeth 27 are in their passive position. Moreover, to guarantee band 3 cutting, in the operating zone 12 each first tooth 15 is partly inserted in a radial seat 16 made in the matrix roller 9 left free by a second tooth 27 retracted in the matrix roller 9.

To guarantee an optimum cut, the size of the radial seats 16 of the second teeth 27 preferably matches that of the head 33 of the first teeth 15, allowing play to be minimized when the first teeth 15 are inserted in them. However, in this case, since insertion of the first teeth 15 in the radial seats 16 of the matrix roller 9 occurs during synchronized rotation of the matrix roller 9 and the punching roller 8, the first teeth 15 and/or the seats 16 must be shaped to allow coupling with the seats 16 and/or the first teeth 15. In particular, the walls 34, 35 of the first teeth 15 and/or of the seats 16 positioned transversally to the direction of band 3 feed must be shaped.

FIG. 13 illustrates the case in which the first teeth 15 have an outer head 33 whose section matches that of the radial seats 16, and two side walls 34, 35 (those perpendicular to the direction of feed of the band 3 and therefore the first tooth 15) which, at the head 33, are concave and shaped in such a way as to brush the outer edge of the radial seats 16 during insertion (front wall 34) and removal (rear wall 35) of the first tooth 15 in the radial seat 16 made in the matrix roller 9. In turn, the radial seats 16 of the matrix roller 9 also have two side walls 44, 45 (those perpendicular to the direction of feed of the band 3 and therefore the first tooth 15) which are concave and shaped in such a way that they brush the outer edge of the head 33 of the first teeth 15 during said insertion (rear wall 45) and removal (front wall 44).

When the apparatus 1 is equipped with two or more punching roller 8-matrix roller 9 pairs, located at separate operating zones 12 along the band 3 path, there is also preferably a coupling zone 36, between the two operating zones 12, at which the band 3 leaves the first pair of rollers 8, 9 and is “taken up” by the second pair, with the methods described below.

To make this operation possible, at the coupling zone 36, the punching roller 8 of one pair is operatively connected to the matrix roller 9 of the other pair, to guide band 3 feed between the first and the second operating zones 12.

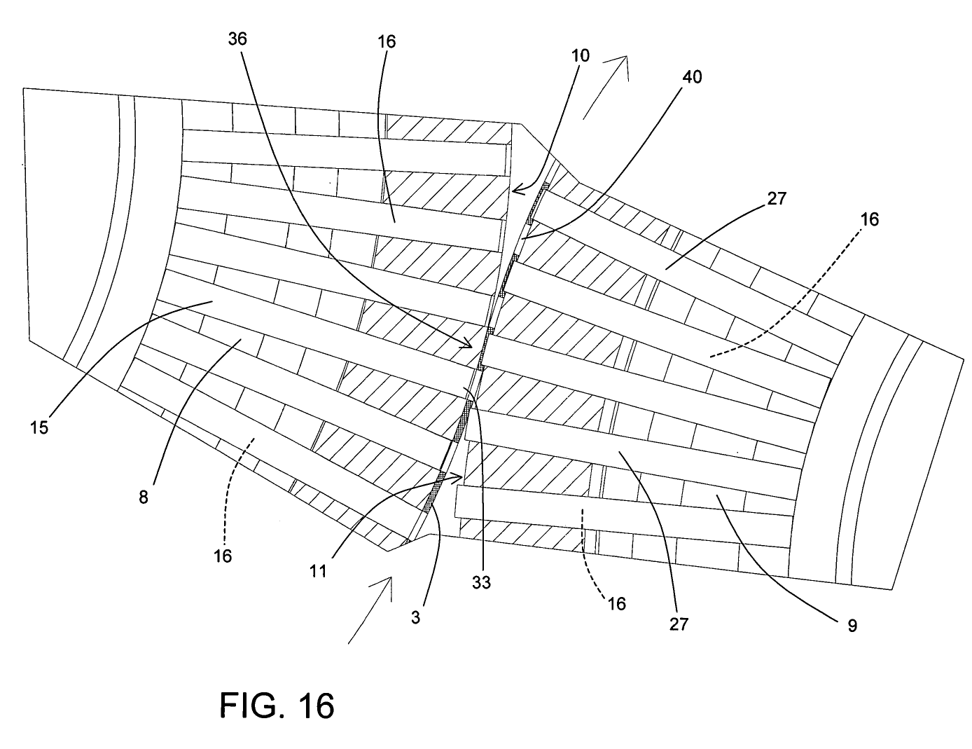

As illustrated in FIGS. 2, 5 and 16, in the preferred embodiment illustrated, the punching roller 8 of the pair upstream relative to the band 3 feed path, is operatively connected to the matrix roller 9 of the pair downstream.

However, in this case, the situation is the reverse of what occurs in the operating zones 12. Indeed, at the coupling zone 36, the second teeth 27 of the matrix roller 9 downstream project from the second outer surface 11 more than the first teeth 15 of the punching roller 8 upstream project from the first outer surface 10 at that point. Moreover, the second teeth 27 of the matrix roller 9 are positioned at areas of the first outer surface 10 of the punching roller 8 that have no first teeth 15, just as the first teeth 15 of the punching roller 8 are positioned at areas of the second outer surface 11 of the matrix roller 9 that have no second teeth 27.

Advantageously, at the coupling zone 36, the first teeth 15 of the punching roller 8 in the pair upstream do not project from the first outer surface 10.

Finally, at the coupling zones 36 the first and the second outer surfaces 10, 11 are normally separated by a distance which substantially corresponds to the thickness of the band 3. As occurs in the operating zones 12, also at the coupling zone 36, in practice, the first and the second outer surfaces 10, 11 make contact with the band 3.

The apparatus 1 is also equipped with means 37 for cleaning the matrix roller 9 (for example, brushes) located at a zone of the matrix roller 9 where the second teeth 27 are in the active position (a position diametrically opposed to the operating zone 12 in the embodiment illustrated).

Operation of the apparatus 1 disclosed is derived from what is described above from a structural viewpoint.

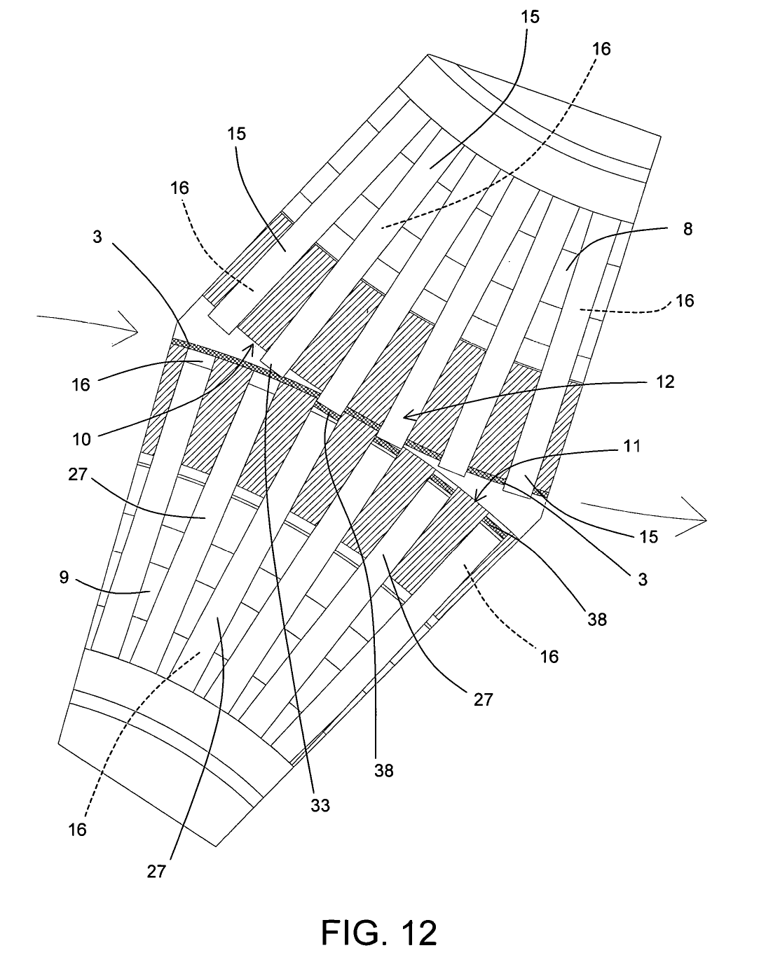

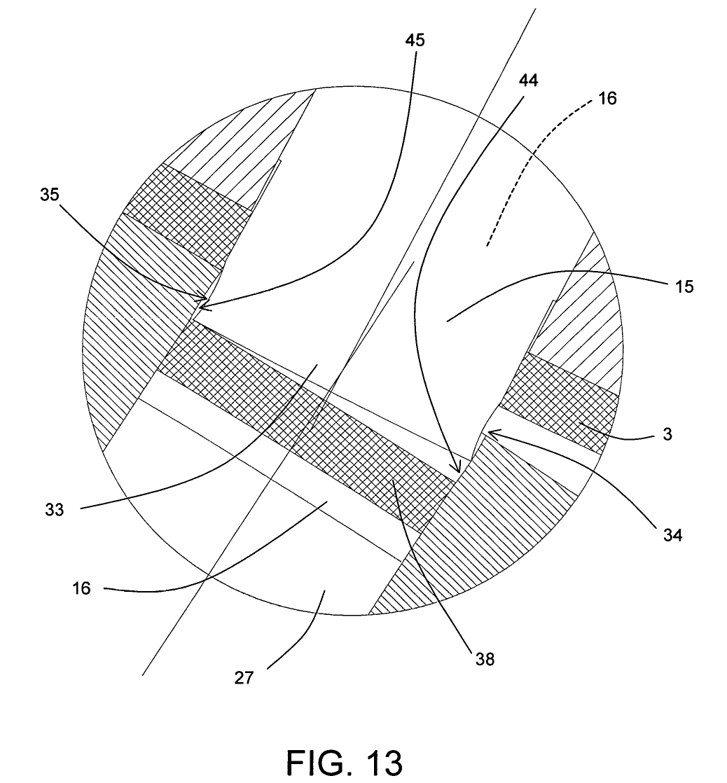

The continuous band 3 enters through the infeed section and reaches the first (or the only) operating zone 12. Here, operating in conjunction with one another, the radial seats 16 of the matrix roller 9 and the first teeth 15 of the punching roller 8, remove portions (processing waste) of the band 3, creating a distribution of holes through the band 3 (FIGS. 12 and 13).

The processing waste 38, which at the operating zone 12 outfeed is inserted in the radial seats 16 of the matrix roller 9, during continuation of the matrix roller 9 rotation, is pushed outwards by the second teeth 27 which move to the active position. At this point, the waste 38 can be removed by the cleaning means 37.

At the same time, the band 3 continues on its path, coupled to the first teeth 15 of the punching roller 8, until the first teeth 15 move to the non-operating position, releasing themselves from it.

At this point the band 3 can be taken up and sent towards the outfeed section 5, or towards a second operating zone 12, according to requirements.

In particular, passage through two or more operating zones 12 is preferable, if not necessary, when grids 2 with particularly thin strips 39 and/or a high density of holes 40 at least in the longitudinal direction (relative to the band 3) must be produced.

The radial movement of the first and second teeth 15, 27 prevents the descent below a predetermined distance, which depends on the roller dimensions, between two rows 17 of adjacent teeth 15, 27 (longitudinally relative to the band 3).

When there is also a coupling zone 36, the band 3 enters the coupling zone 36 when it has just been or is being released from the first teeth 15 of the punching roller 8 upstream. During this step, the band 3 still adheres to the first outer surface 10 of the punching roller 8 upstream. At this point, the band 3 is partially penetrated by the second teeth 27 of the matrix roller 9 downstream and therefore adheres to said matrix roller 9, following it as far as the next operating zone 12. When it gets there, the second teeth 27 which had coupled to it are returned to the passive position and the band 3 can be subject to the creation of more holes 40 located in intermediate positions between the two rows of holes 40 made in the previous sections.

FIG. 15 shows an example of a band 3 processed with an apparatus 1 made according to the present invention.

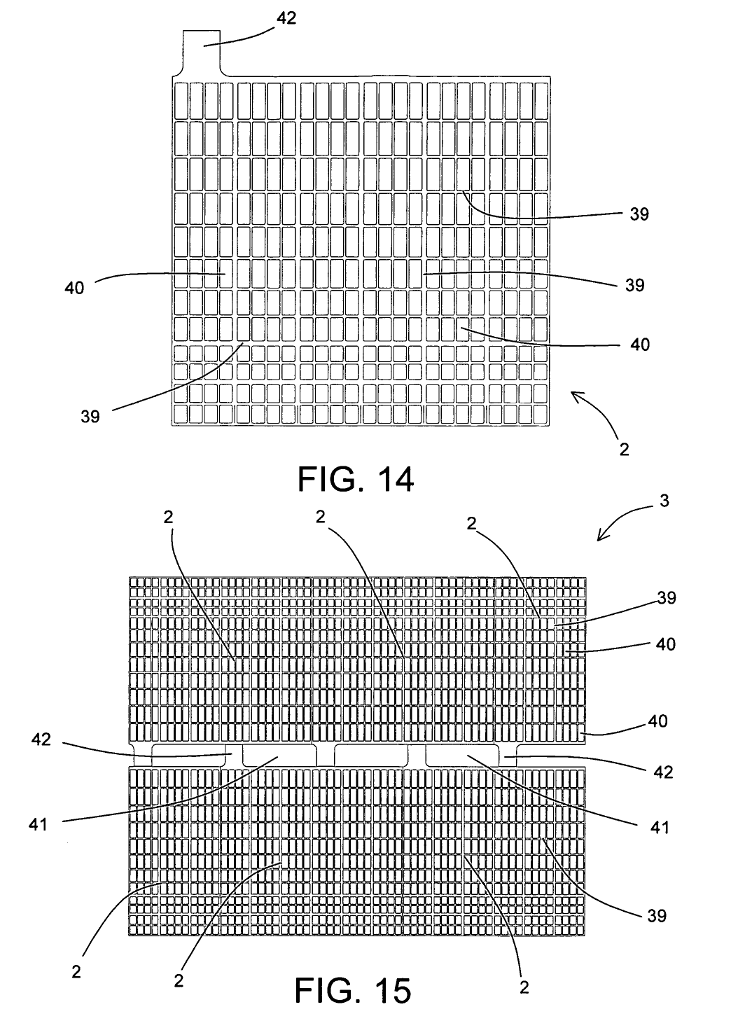

The band 3 is processed to create two opposite continuous grids 2, which once cut form grids 2 like that illustrated in FIG. 14 (FIG. 15 also shows the subsequent cutting margins). Whilst the small holes 40 in the grid 2 are produced as described above, the bigger holes 41, which separate the ends 42 of the different grids 2, are advantageously obtained by separate processing upstream or downstream of the apparatus 1 disclosed.

In any event, nothing prevents said larger holes 41 from being obtained using an apparatus 1 such as that disclosed, whether it is the same apparatus used to make the smaller holes 40 or a separate apparatus.

The present invention brings important advantages.

Firstly, the apparatus allows the continuous formation of grids with inner strips having any thickness and with a high density of holes.

Secondly, optimum quality grids can be obtained with high productivity.

It should also be noticed that the present invention is relatively easy to produce and that even the cost linked to implementation of the invention is not very high relative to the results that it allows.

The invention described may be subject to many modifications and variations without thereby departing from the scope of the inventive concept.

All details of the invention may be substituted with technically equivalent elements and in practice all of the materials used, as well as the shapes and dimensions of the various components, may be any according to requirements.

What is claimed:

1) an apparatus for forming continuous metal grids, in particular producing grids for batteries, in which there is a feed path for a continuous metal band, extending from an infeed section to an outfeed section, the apparatus comprising:
a supporting structure;
at least one punching roller mounted on the supporting structure, positioned transversally to the band feed path and having a first outer surface;
at least one matrix roller mounted on the supporting structure, positioned parallel with the punching roller and in the corresponding position to it on the opposite side of the band feed path, the matrix roller having a second outer surface;
the first and the second outer surfaces being separated from one another by a distance substantially corresponding to the thickness of the band at an operating zone of the band path;
the punching roller and the matrix roller rotating in such a way that they are synchronized with one another at a peripheral speed substantially corresponding to the band feed speed;
wherein the punching roller comprises a plurality of first teeth positioned radially relative to the first outer surface and each mobile cyclically, with each punching roller rotation, between an operating position in which it projects from the first outer surface and a non-operating position in which it does not project from the first outer surface; the matrix roller comprising a plurality of second teeth positioned radially relative to the second outer surface and each mobile cyclically, with each matrix roller rotation, between a passive position in which it is retracted relative to the second outer surface and an active position in which it is not retracted relative to the second outer surface; the first teeth being in the operating position and the second teeth being in the passive position when they are at the operating zone; and in said operating zone each first tooth being partly inserted in the matrix roller where a second tooth is retracted in the matrix roller, to cut the band.

2) The apparatus according to claim 1, wherein, in the non-operating position, the first teeth are substantially aligned with the first outer surface.

3) The apparatus according to claim 1, wherein, in the non-operating position, the first teeth are retracted relative to the first outer surface.

4) The apparatus according to claim 1, wherein, in the active position, the second teeth are substantially aligned with the second outer surface.

5) The apparatus according to claim 1, wherein, in the active position, the second teeth project from the second outer surface.

6) The apparatus according to claim 1, wherein the first teeth are slidably inserted in radial seats made in the punching roller from the first outer surface, and comprising first drive means for the first teeth, inserted inside the punching roller.

7) The apparatus according to claim 6, wherein the first drive means comprise a first shaft inside the punching roller and having a first cam surface relative to the axis of rotation of the punching roller, and first mechanical means connected to the first teeth and slidably connected to the first cam surface to follow its movement, the first shaft remaining stationary during punching roller rotation.

8) The apparatus according to claim 7, wherein the first cam surface consists of a first cylindrical surface positioned eccentrically relative to the axis of rotation of the punching roller, and the first mechanical means comprising at least a first ring whose inside is shaped to match the first cylindrical surface and which is rotatably mounted on the latter, the first teeth being coupled to the first ring.

9) The apparatus according to claim 1, wherein the second teeth are slidably inserted in radial seats made in the matrix roller starting from the second outer surface, and comprising second drive means for the second teeth, inserted inside the matrix roller.

10) The apparatus according to claim 9, wherein the second drive means comprise a second shaft inside the matrix roller and have a second cam surface relative to the axis of rotation of the matrix roller, and second mechanical means connected to the second teeth and slidably connected to the second cam surface to follow its movement, the second shaft remaining stationary during matrix roller rotation.

11) The apparatus according to claim 10, wherein the second cam surface consists of a second cylindrical surface positioned eccentrically relative to the axis of rotation of the matrix roller, and the second mechanical means comprising at least one second ring whose inside is shaped to match the second cylindrical surface and which is rotatably mounted on the latter, the second teeth being coupled to the second ring.

12) The apparatus according to claim 1, wherein the first and the second teeth are regularly distributed on the respective first and second outer surfaces, along a plurality of rows parallel with the axis of rotation of the relative roller.

13) The apparatus according to claim 12, wherein the teeth of each row are grouped in one or more rigid blocks.

14) The apparatus according to claim 1, wherein, in the operating position, the first teeth are inserted in second teeth radial housing seats made radially in the matrix roller, and wherein the first teeth and/or the seats are shaped to allow coupling respectively with the seats and the first teeth during rotation of the respective rollers.

15) The apparatus according to claim 1, comprising a plurality of punching rollers, each paired with a matrix roller.

16) The apparatus according to claim 1, comprising one after another, along the band path, at least two punching roller-matrix roller pairs at two separate operating zones along the band path, and wherein, at a coupling zone the punching roller of one pair is operatively connected to the matrix roller of the other pair, guiding band feed between the first and the second operating zones.

17) The apparatus according to claim 16, wherein the punching roller of the pair upstream with reference to the band feed path is operatively connected to the matrix roller of the pair downstream, the second teeth of said matrix roller, at the coupling zone, projecting at least more than the first teeth of said punching roller and being positioned at areas of the first outer surface of the punching roller that have no first teeth, partially penetrating the band.

18) The apparatus according to claim 17, wherein, at the coupling zone, the first teeth of the punching roller of the pair upstream do not project from the first outer surface.
